(19) United States
(12) Patent Application Publication
(10) Pub. No.: US 2018/0234547 A1
(43) Pub. Date: Aug. 16, 2018

(54) SYSTEM AND SERVER FOR TELEPHONE ANSWER

(71) Applicants: KABUSHIKI KAISHA TOSHIBA, Minato-ku (JP); Toshiba Infrastructure Systems & Solutions Corporation, Kawasaki-shi (JP)

(72) Inventor: Mitsuru HOSAKA, Tachikawa (JP)

(73) Assignees: KABUSHIKI KAISHA TOSHIBA, Minato-ku (JP); Toshiba Infrastructure Systems & Solutions Corporation, Kawasaki-shi (JP)

(21) Appl. No.: 15/829,293

(22) Filed: Dec. 1, 2017

(30) Foreign Application Priority Data
Feb. 13, 2017 (JP) 2017-024349

(51) Int. Cl. H04M 3/523; H04M 3/51

(52) U.S. Cl. CPC H04M 3/5235; H04M 3/5183

(57) ABSTRACT

According to one embodiment, a system includes a telephone exchange and a server. The telephone exchange is configured to assign an incoming call to one of a plurality of telephone sets preset for types of service. The server is configured to, if waiting calls about a first service that are waiting to be assigned by the telephone exchange to the telephone sets exceed a threshold set in advance, notify the telephone exchange to set to the first service a telephone set that has been set to a second service different from the first service. The telephone exchange is configured to set the telephone set that has been set to the second service to the first service in accordance with a notice from the server.

### CROSS-REFERENCE TO RELATED APPLICATIONS

This application is based upon and claims the benefit of priority from the Japanese Patent Application No. 2017-024349, filed Feb. 13, 2017, the entire contents of which are incorporated herein by reference.

### FIELD

Embodiments described herein relate generally to a system and a server for telephone answering.

### BACKGROUND

In a call center which receives telephone inquiries or the like from customers, service types are classified in accordance with the content of calls, so that each call is received by an operator who is knowledgeable in the service type of the call (for example, general inquiries, consulting, complaints, orders, English assistance, etc.). If a Computer Telephony Integration (CTI) system has been introduced to efficiently respond to telephone calls from customers, an operator can appropriately handle customer's calls corresponding to classified services by utilizing information provided from a management server and displayed on a computer (PC).

In the management server, a service type is assigned to an ID that an operator inputs in logging in the service system, so that appropriate information is displayed on the PC which the operator uses. In a private branch exchange (PBX) to sort inquiries from customers to appropriate operators, service types are assigned to login IDs of operators in advance. The PBX detects that an operator logs in the system via a CTI server and transmits a call of an inquiry to only the operator who can handle the inquiry.

The PBX has a function to record statistical information; for example, if there is no available operator who can receive a call from a public network, the PBX records the number of calls (waiting calls) that are waiting for receipt. In the call center, the number of operators who should handle each type of service is determined with reference to the statistical information recorded in the PBX.

In the call center, when waiting calls about a specific type of service temporarily increase, the calls can temporarily be dealt with by an operator who is assigned to another type of service. For example, to make operator C, who is engaged in service 1, handle service 2, the login ID of the operator C is newly defined to service 2. If the new login ID of the operator is represented by, for example, “ID:C′”, the service type of “ID:C′” is set to be service 2 in the PBX. The management server registers the service type of the operator who logs in with “ID:C′” as service 2. Operator C logs out once from the system to complete service 1 in which the operator C has been engaged by log-in with “ID:C”, and then logs in the system again with “ID:C′”. Thus, the incoming call about service 2 is transmitted to operator C, so that the operator can engage in service 2.

As described above, in the conventional system, to deal with customer's calls which fluidly change, for example, when waiting calls in a specific type of service temporarily increase, it is necessary to assign an operator who is engaged in another service to the specific type of service. In this case, an appropriate decision must promptly be made. In addition, the operator who is going to change the type of service to a new one must first complete the service, log out from the system, and then log in the system again with another ID for the new service.

### BRIEF DESCRIPTION OF THE DRAWINGS

FIG. 1 is a block diagram showing a configuration of a telephone answering system according to an embodiment;

FIG. 2 is a block diagram showing a configuration of a management server according to the embodiment;

FIG. 3 is a diagram showing an example of statistical information recorded in a PBX according to the embodiment;

FIG. 4 is a diagram showing an example of a backup threshold table stored in the management server according to the embodiment;

FIG. 5 is a diagram showing an example of a backup candidate operator table stored in the management server according to the embodiment;

FIG. 6 is a sequence diagram illustrating operations of the telephone answering system according to the embodiment;

FIG. 7 is a flowchart illustrating operations of the management server according to the embodiment; and

FIG. 8A and FIG. 8B are diagrams showing situations of operators engaged in service according to the embodiment.

### DETAILED DESCRIPTION

In general, according to one embodiment, a system includes a telephone exchange and a server. The telephone exchange is configured to assign an incoming call to one of a plurality of telephone sets preset for types of service. The server is configured to, if waiting calls about a first service that are waiting to be assigned by the telephone exchange to the telephone sets exceed a threshold set in advance, notify the telephone exchange to set to the first service a telephone set that has been set to a second service different from the first service. The telephone exchange is configured to set the telephone set that has been set to the second service to the first service in accordance with a notice from the server.

Various embodiments will be described hereinafter with reference to the accompanying drawings.

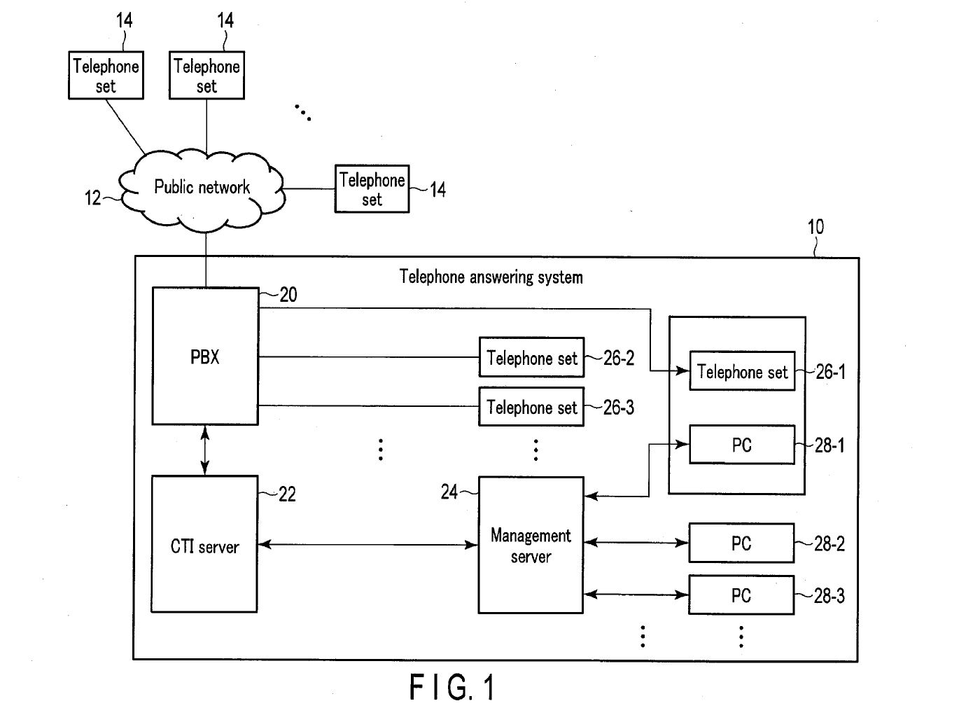

FIG. 1 is a block diagram showing a configuration of a telephone answering system 10 according to the embodiment. The telephone answering system 10 receives telephone inquiries from customers via a public network 12. Specifically, the system 10 receives a call from a customer via a telephone set 14, and allows an operator to promptly deal with the matter requested by the customer in accordance with a type of service (for example, general inquiries, consulting, complaints, orders, English assistance, etc.).

The system 10 includes a private branch exchange (PBX) 20, a CTI server 22, a management server 24, a plurality of telephone sets 26 (26-1, 26-2, 26-3, . . . ), and a plurality of computers (PCs) 28 (28-1, 28-2, 28-3, . . . ). The PBX 20, the CTI server 22, the management server 24, and the PCs 28 are connected to one another through a LAN (Local Area Network), which is not shown.

The PBX 20 communicates with the telephone set 14 connected to the public network 12, receives a call from the telephone set 14, and assigns it to one of the telephone sets 26 (26-1, 26-2, 26-3, . . . ). In the PBX, the telephone sets 26 are preset to types of service requested by calls. Therefore, the call from the telephone set 14 is assigned to the telephone set 26 corresponding to the requested type of service. The PBX 20 can change the setting of the type of service for each of the telephone sets 26 in accordance with a notice from the management server 24 received via the CTI server 22. The PBX 20 has a function to record statistical information, such as the number of calls (waiting calls) that are waiting for receipt because a call from the public network 12 cannot be assigned to the telephone set 26, that is, there is no available operator. The statistical information is periodically collected in the management server 24.

The CTI server 22 operates the management server 24 and the PCs 28 in cooperation with the PBX 20. For example, the CTI server 22 performs control, for example, notifying the management server 24 of a response to a call to the PBX 20 from a customer, a disconnection of the call, and a caller's number, and causing the PC 28 to display the notification.

The management server 24 specifies the customer corresponding to the caller's number notified via the CTI server 22, and provides information to handle the service in reply to the inquiry of the customer via the display screen of the PC 28 used by the operator who is going to respond to the inquiry. The information includes, for example, personal information of the customer, inquiry histories, product purchase histories, and examples of general answers to inquiries.

The management server 24 has a function of collecting statistical information from the PBX 20, and if waiting calls about a first service (service type) exceed a preset threshold, notifying the PBX 20 to set to the first service the telephone set 26 that has been set to a second service different from the first service.

The telephone sets 26 (26-1, 26-2, 26-3, . . . ) are respectively used by the corresponding operators to respond to incoming calls from the telephone set 14. The PCs 28 (28-1, 28-2, 28-3, . . . ) are respectively used by the corresponding operators to carry out processes corresponding to the service types. The PC 28 has functions of a general personal computer. The PC 28 screen-displays appropriate information corresponding to the service type from the information provided by the management server 24, and data corresponding to an operator's input operation on a keyboard or a pointing device is input to the PC 28.

The operator uses an associated pair of the telephone set 26 and the PC 28. As shown in FIG. 1, for example, the telephone set 26-1 and the PC 28-1 are associated. The operator logs in the system by inputting a login ID in the PC 28; as a result, the PBX 20 assigns an incoming call of the service type, which the operator is in charge, to the logged-in PC 28 and the associated telephone set 26.

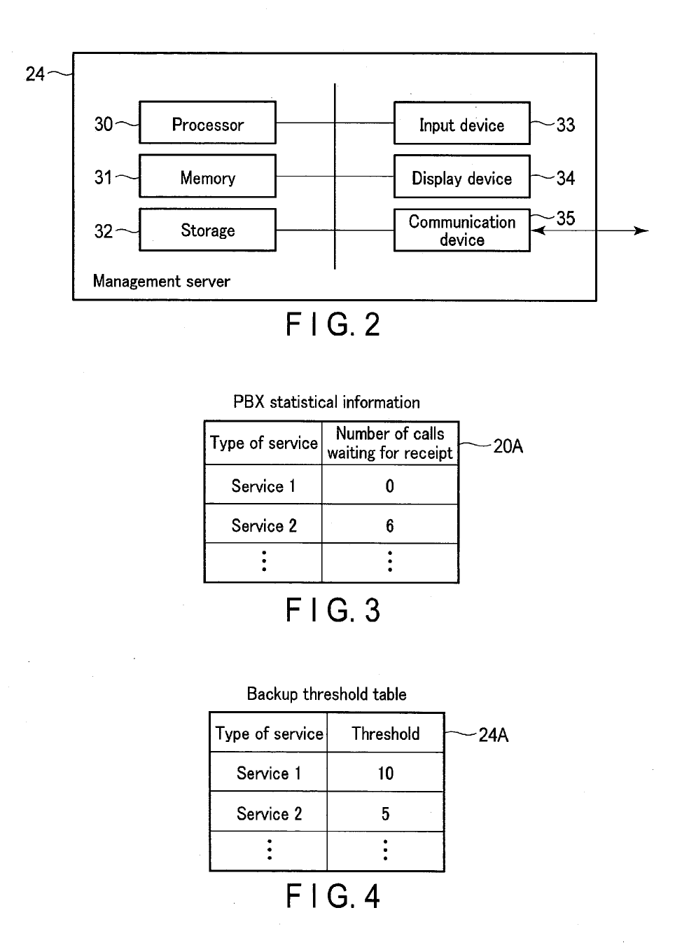

FIG. 2 is a block diagram showing only a main configuration of the management server 24 according to the embodiment. The management server 24 has functions of a general computer and server. The management server 24 includes a processor 30, a memory 31, a storage 32, an input device 33, a display device 34, and a communication device 35.

The processor 30 performs various functions by executing programs stored in the memory 31. For example, the processor 30 executes a backup operator setting program, so that if waiting calls about a first service exceed a preset threshold based on the statistical information collected by the PBX 20, the processor 30 can notify the PBX 20 to set to the first service the telephone set 26 that has been set to a second service different from the first service.

The memory 31 includes a storage area for use in reading and writing data and programs executed by the processor 30.

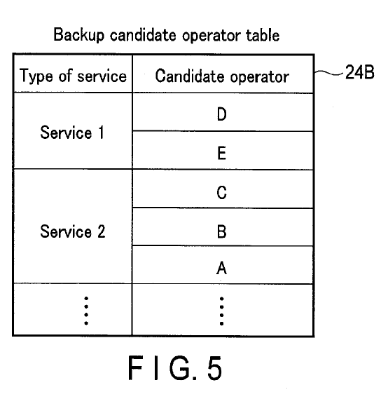

The storage 32 stores and retains various programs and various data. The data stored in the storage 32 include a backup threshold table (see FIG. 4), a backup candidate operator table (see FIG. 5), etc. that are used in a process of executing the backup operator setting program. Details of the tables are described later.

The input device 33 is a keyboard, a pointing device, or the like, and is operated by an administrator of the call center. The display device 34 comprises a liquid crystal display (LCD) etc., and screen-displays information based on processing results of the processor 30. The communication device 35 controls communication with the PBX 20, the CTI server 22, and the PC 28.

FIG. 3 is a diagram showing an example of statistical information 20A recorded in the PBX 20 according to the embodiment; if there is no available operator able to handle a service, the PBX 20 makes a call from the telephone set 14 received via the public network 12 pending in a state of waiting for receipt. The statistical information 20A is information to manage the number of calls that are waiting for receipt by each type of service.

In the example shown in FIG. 3, the number of calls waiting for receipt about service 1 is “0”; that is, there are no calls waiting for receipt. The number of calls waiting for receipt about service 2 is “6”; that is, there are six customers who require responses. If any operator starts responding or if a call from the telephone set 14 is disconnected, information on the number of calls waiting for receipt is minus-updated (decremented).

FIG. 4 is a diagram showing an example of a backup threshold table 24A stored in the management server 24 according to the embodiment. A threshold of the number of calls waiting for receipt to determine a state that requires backup of an operator for each type of service is preset in the backup threshold table 24A. In the backup threshold table 24A, different thresholds are individually set for the respective types of service based on, for example, a tendency of concentration of calls of the respective types of service, periods of time necessary to deal with the service, etc.

In the example shown in FIG. 4, the threshold “10” set for service 1 means that a backup operator is necessary if the number of calls waiting for receipt exceeds 10. The threshold “5” set for service 2 means that a backup operator is necessary if the number of calls waiting for receipt exceeds 5. The thresholds set in the backup threshold table 24A can be appropriately changed by an administrator of the call center, for example, by operating the input device 33.

FIG. 5 is a diagram showing an example of a backup candidate operator table 24B stored in the management server 24 according to the embodiment. In the backup candidate operator table 24B, an operator (typically, an operator of high ability or with several years of experience), who can deal with a type of service different from that normally assigned to him or her if necessary, is registered in advance for each type of service.

In the backup candidate operator table 24B, at least one backup candidate operator is registered in order of priority for each type of service. The order of priority of the backup candidate operators is determined, for example, in order of registration in the backup candidate operator table 24, in order of years of experience, or in order of ability, or based on conditions, such as priorities individually designated by an administrator.

In the example shown in FIG. 5, backup candidate operator D is registered at a higher priority than backup candidate operator E with regard to service 1. With regard to service 2, backup candidate operator C is registered at the highest priority, and then backup candidate operators B and C are registered in this order. Operators A, B, and C are normally in charge of service 1. Operators D and E are normally in charge of service 2.

To simplify explanation, FIG. 5 shows an example in which there are two types of service, and the operators of one type of service are registered as backup candidate operators of the other type of service. If there are three or more types of service, an operator and a backup candidate operator can be determined in any relationship. For example, a specific operator can be registered as a backup candidate operator of a plurality of types of service.

Furthermore, although the priorities of the backup operators are set in advance in the example shown in FIG. 5, the priorities can be dynamically adjusted. For example, to prevent a specific operator from being repeatedly assigned to another type of service for backup, the priorities of backup candidate operators may be automatically adjusted in increasing order of the number of times of backup in the past.

The management server 24 notifies the PBX 20 of a change of the type of service of an operator based on the backup candidate operator table 24B. As a result, an incoming call about the type of service to be backed up is transferred to the telephone set 26 that this operator is using.

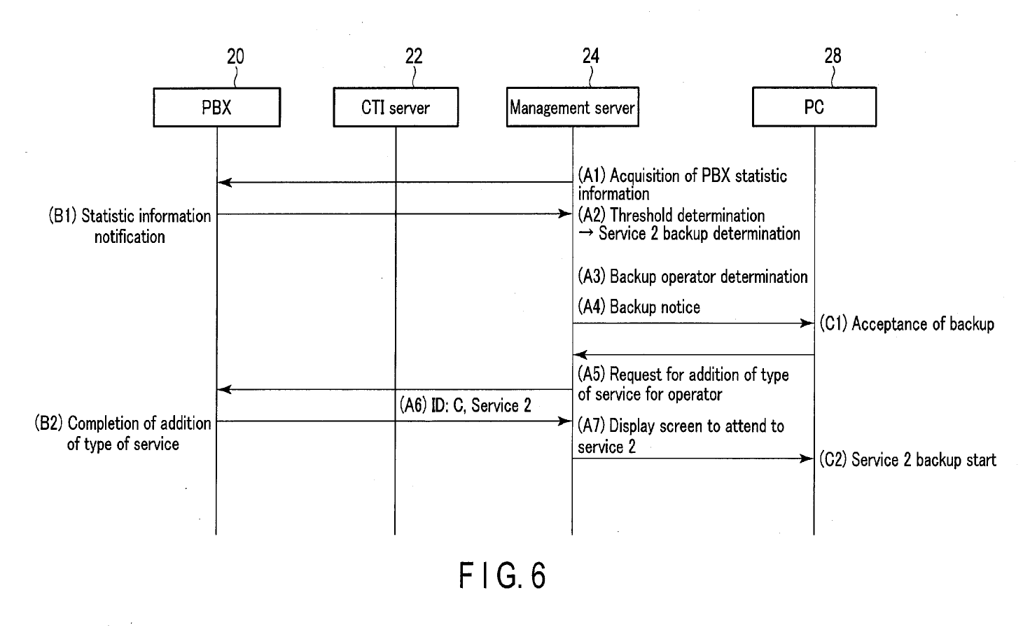

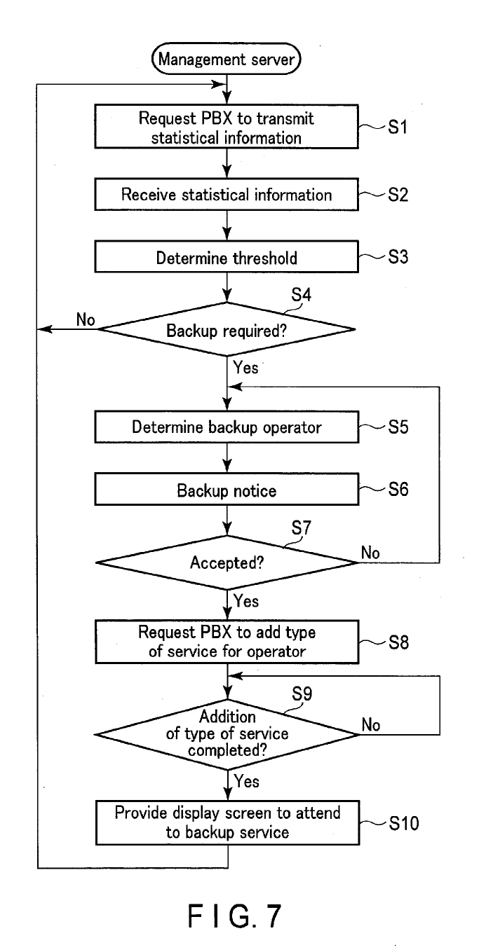

Next, operations of the telephone answering system of this embodiment will be explained. FIG. 6 is a sequence diagram illustrating operations of the telephone answering system according to the embodiment. FIG. 7 is a flowchart illustrating operations of the management server 24 according to the embodiment. In the following explanation, an initial state is a state in which service 1 is assigned to operators A, B, and C, while service 2 is assigned to operators D and E.

As shown in FIG. 6, the management server 24 periodically executes acquisition of statistical information stored in the PBX (A1). In other words, as shown in FIG. 7, the management server 24 requests statistical information from the PBX 20 via the CTI server (step S1). The time interval of acquiring statistical information from the management server 24 can be set shorter as the number of calls from customers increases, accordingly, calls waiting for receipt can be promptly dealt with.

As shown in FIG. 6, the PBX 20 notifies the management server 24 of statistical information (B1) via the CTI server 22 in accordance with a request from the management server 24. The PBX 20 is set not only to notify statistical information in accordance with a request from the management server 24 (acquisition of statistical information stored in the PBX (A1)), but also to automatically notify statistical information based on the number of waiting calls from customers.

As shown in FIG. 7, upon receipt of a notification of statistical information (B1) (step S2), the management server 24 determines whether or not the number of calls waiting for receipt for each type of service exceeds the threshold of the service set in the backup threshold tables 24A (step S3). For example, if the statistical information received from the PBX 20 are those shown in FIG. 3 and FIG. 4, with regard to service 1, the management server 24 determines that the number of waiting calls is “0” and therefore does not exceed the threshold “10”. With regard to service 2, the management server 24 determines that the number of waiting calls “6” exceeds the threshold “5”. As a result, the management server 24 determines that a backup operator is required for service 2 (A2, Yes in step S4).

With reference to the backup candidate operator table 24B, the management server 24 determines a specific backup operator from a plurality of backup operators registered for service 2 in advance in accordance with the priorities set in the tables (A3, step S5). In the example of the backup candidate operator table 24B shown in FIG. 5, operator C is determined as a backup operator. As a condition at this time, the backup candidate operator needs to have logged into the system. If operator C has logged off from the system, the priorities will be changed and operator B who has logged into the system is determined to be a backup operator.

The management server 24 transmits a backup notice to the effect that operator C is determined to be a backup operator to the PC 28 which operator C (who has logged in) is using (A4, step SG). The PC 28 that receives the backup notice displays that the operator is selected as a backup operator and the type of service, for example, on the display screen (pop-up display or the like). As a result, the PC 28 causes operator C to ascertain the situation and stands by for an input of a response of whether or not operator C can start the service as a backup operator. For example, the PC 28 displays a button that prompts operator C to determine whether or not to accept a request for backup.

Operator C is notified that the operator has been selected to be a backup operator by a method of displaying text information on the screen, or a method of outputting a preset speech signal through headphones that the operator is wearing, or a method of causing the operator to visually recognize the notification by lighting (or flickering) a light source, such as a light emitting diode (LED).

If operator C, who receives the backup notice, cannot back up the service due to a situation of the service currently being handled or the like, the operator performs an operation of refusal in reply the backup notice via the PC 28. If there is no reply from the PC 28 in a preset period (for example, one minute) after receiving the backup notice, it is determined that operator C indicates an intention of refusal in reply to the backup notice.

If the management server 24 does not receive a reply to accept the backup notice (No in step S7), it refers to the backup candidate operator table 24B and sends a backup notice in the same manner as described above to a PC 28 of operator B who has the second highest priority.

On the other hand, if operator C makes a reply to accept the backup notice, the PC 28 notifies the management server 24 of acceptance of the backup (C1), as shown in FIG. 6. Upon acknowledging the acceptance of the backup from the PC 28, the management server 24 transmits a request for addition of a type of service for the operator via the CTI server 22 (A5, step S8). Specifically, the management server 24 notifies the PBX 20 of a login ID (“ID:C”) of operator C that requires a change of the type of service for the backup, and information indicative of the type of service (service 2) to be backed up (A6).

Upon receipt of the request for addition of a type of service for the operator from the management server 24, the PBX 20 adds operator C corresponding to the notified login ID (“ID:C”) as an operator who handles service 2. In other words, the telephone set 26 which operator C is using is set as a target to which a call waiting for receipt about service 2 is to be assigned. Accordingly, the PBX 20 assigns the call waiting for receipt about service 2 to the telephone set 26 which operator C is using, so that operator C can handle service 2.

As shown in FIG. 6, upon completion of the requested setting, the PBX 20 notifies the management server 24 of the completion of addition of the type of service (B2) via the CTI server 22.

As shown in FIG. 7, when the completion of addition of the type of service is notified from the PBX 20 (Yes in step 9), the management server 24 provides the PC 28 that operator C is using (operator C has logged in) with information to handle service 2 via a display screen (A7, step S10). The information includes, for example, personal information of the customer, inquiry histories, product purchase histories, and examples of general answers to inquiries. The PC 28 allows operator C to handle service 2 (C2).

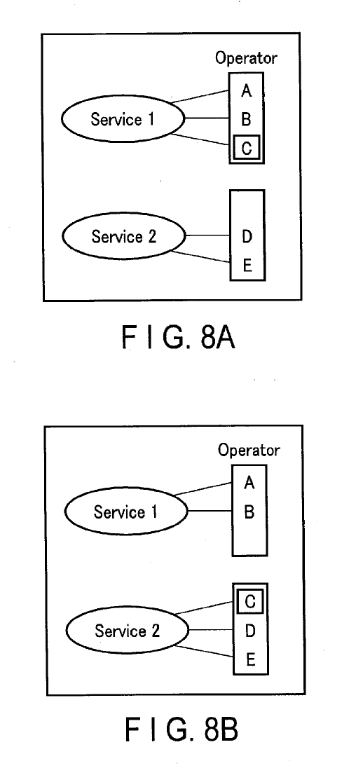

FIGS. 8A and 8B show states that the service which operator C handles has changed from service 1 to service 2 for backup. Operator C can handle service 2 only by making an acceptance reply to the backup notice from the management server 24 without logging in with a new login ID for service 2 to be backed up.

Furthermore, if backup of a service is required (if the number of waiting calls exceeds the threshold), a backup operator can be determined from a plurality of backup candidate operators preset in the management server 24. Therefore, the administrator of the call center does not need to select a backup operator.

Accordingly, when a specific type of service requires backup, the telephone answering system of this embodiment can easily and appropriately change the service that an operator can handle. The embodiment is applicable not only to a call center, but also to a contact center utilizing the telephone answering system.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A system for telephone answering, comprising:
a telephone exchange configured to assign an incoming call to one of a plurality of telephone sets preset for types of service; and
a server configured to, if waiting calls about a first service that are waiting to be assigned by the telephone exchange to the telephone sets exceed a threshold set in advance, notify the telephone exchange to set to the first service a telephone set that has been set to a second service different from the first service, wherein
the telephone exchange is configured to set the telephone set that has been set to the second service to the first service in accordance with a notice from the server.

2. The system of claim 1, wherein the server is configured to provide a computer corresponding to the telephone set that is set to the first service with information to deal with the first service.

3. The system of claim 1, wherein the server is configured to register in advance at least one telephone set assignable to the first service, and to set the at least one registered telephone set to the first service.

4. The system of claim 1, wherein the server is configured to register at least one telephone set assignable to the first service in order of priority, and to set the at least one registered telephone set to the first service in order of priority.

5. The system of claim 1, wherein the server is configured to set the threshold in advance for each of the types of service.

6. A server for controlling a telephone exchange that assigns an incoming call to one of a plurality of telephone sets preset for types of service, the server comprising:
a circuit configured to, if waiting calls about a first service that are waiting to be assigned to the telephone sets exceed a threshold set in advance, notify the telephone exchange to set to the first service a telephone set that has been set to a second service different from the first service.

7. The server of claim 6, further comprising a circuit configured to provide a computer corresponding to the telephone set that is set to the first service with information to deal with the first service.

8. The server of claim 6, further comprising a circuit configured to register in advance at least one telephone set assignable to the first service, and to set the at least one registered telephone set to the first service.

9. The server of claim 6, further comprising a circuit configured to register at least one telephone set assignable to the first service in order of priority, and to set the at least one registered telephone set to the first service in order of priority.

10. The server of claim 6, further comprising a circuit configured to set the threshold in advance for each of the types of service.

11. A computer program for causing a computer to control a telephone exchange to assign an incoming call to one of a plurality of telephone sets preset for types of service, the program comprising code for causing the computer to:
if waiting calls about a first service that are waiting to be assigned to the telephone sets exceed a threshold set in advance, notify the telephone exchange to set to the first service a telephone set that has been set to a second service different from the first service.
